(19) United States
(12) Patent Application Publication
(10) Pub. No.: US 2006/0052010 A1
(43) Pub. Date: Mar. 9, 2006

(54) Socket equipped with a centring ring for a wedge-base

(76) Inventors: Gerard Dietz, Bobigny (FR); Laurent Meister, Bobigny (FR)

Correspondence Address: MORGAN & FINNEGAN, L.L.P., 3 WORLD FINANCIAL CENTER, NEW YORK, NY, 10281-2101, US

(21) Appl. No.: 11/221,655

(22) Filed: Sep. 7, 2005

(30) Foreign Application Priority Data
Sep. 7, 2004 (FR) 04 09 479

(51) Int. Cl. H01R 24/00

(52) U.S. Cl. 439/699.2

(57) ABSTRACT

The socket for a wedge-base lamp according to the invention comprises a base and at least two electrical contact blades mounted in the base in order to electrically connect electrodes of the lamp to an electrical supply circuit. The electrical contact blades each comprise an elastic part forming a clamp in which the glass cap of the lamp is inserted. According to a first aspect, the base is provided with at least one part in contact with the bottom of the bulb of the lamp in order to centre the lamp in a predetermined manner in the base and to oppose any movement of the lamp with respect to the base. According to a preferred embodiment, the part of the socket in contact with the bottom of the bulb is included in a centring piece mounted in an intermediate manner between the base and the bulb of the lamp. According to another aspect, the contact blades are produced from spring steel. The invention finds a favoured application in lighting and/or signalling devices for automobiles, in particular signalling lights.

### FIELD OF THE INVENTION

The present invention concerns in general terms a field of sockets for wedge-base filament lamps. More particularly, the invention concerns a socket for a wedge-base lamp suitable for use in lighting and/or signalling devices for automobiles, in particular signalling lights.

### BACKGROUND OF THE INVENTION

Mention will be made below only of applications to signalling lamps for reasons of conciseness.

Lamps with a glass base (“wedge-base lamp” in English) have a certain advantage for integration in an automobile signalling light. This is because these lamps have the advantage of reduced bulk compared with bayonet lamps used more conventionally in signalling lights. This characteristic of less bulk is of such a nature as to facilitate the production of more compact signalling lights and offering better optimisation of the surfaces of the optical elements, such as reflector or others, included in these lights.

Thus wedge-base lamps of the W16W type can advantageously replace bayonet lights of the P21W type in certain signalling lights.

The use of wedge-base lamps is however restricted by the difficulties encountered by manufacturers in keeping a tight tolerance for the positioning of the filament in the light bulb. For example, in the case of a lamp of the W16W type, the tolerance on the distance between the filament and the lamp retention grooves may be around ±2.3 mm.

However, in a signalling light, just as in a headlight, the lamp filament must occupy a clearly determined position with respect to the optical elements included in the light or headlight, in order to obtain the required optical performance. The result is a very tight dimensional tolerance for the mechanical connection between the lamp and its socket.

The sockets currently available for wedge-base lamps are not very suited to use in a signalling light for an automobile. This is because the sockets respond poorly to the various mechanical stresses to which a signalling light is generally subjected. Thus tests carried out by the inventors show that the sockets of the prior art do not guarantee a sufficiently reliable positioning of the filament with respect to the optical elements when mechanical vibrations are applied.

Amongst the sockets for wedge-base lamps currently available, a socket intended to be mounted on an electrically insulating substrate 8 is known through the document EP0404135B1.

A view in section of the socket according to EP0404135B1 is shown in FIG. 6 in the present application.

This socket according to EP0404135B1 comprises electrical contact blades in the shape of a hook 6a and 6b and a sheath 7 intended to hold the base of the lamp in the socket.

The strips 6a and 6b are fixed to the substrate 8 and are disposed so as to grip the base 5a of the lamp between them and to ensure electrical contact with electrodes thereof. The strips 6a and 6b each have a hook shape and are produced in a conventional manner from brass or phosphor copper.

The sheet 7 is produced from an electrical insulating material and is fixed by clipping to the substrate. The sheet 7 is provided with two hooks 7a. The hooks 7a are inserted in grooves present in the base 5a and their function is to hold the lamp in position.

The combined action of the strips 6a and 6b and the hooks 7a on the base 5a ensures the retention of the lamp in the socket, but this action is however, not sufficient to satisfy all the constraints which are applied during the design of a signalling light, and in particular in terms of response when the signalling light is subjected to vibration.

The object of the present invention is essentially to provide the prior art with the improvements necessary for a wider user of wedge-base lamps in lighting and/or signalling devices for automobiles.

### SUMMARY OF THE INVENTION

The present invention firstly aims to provide a socket for a wedge-base lamp comprising a base and at least two electrical connection strips mounted in the base for electricity connecting electrodes of the lamp to an electrical supply circuit, the electrical connection strips each comprising an elastic part forming a clamp in which the glass cap of the lamp is inserted. According to the invention the base comprises a centring piece produced in the form of a ring extended, on a first face, by at least one leg able to provide a fixed position of the centring piece on the base and having, on a second face, centring elements forming a part in contact with the bottom of the lamp bulb in order to centre the lamp in the base in a predetermined manner and to oppose any movement of the lamp with respect to the base.

It is considered here that the term “bottom” designates the portion of the bulb that is adjacent to the lamp cap, this portion generally having at least partially a splayed shape or a shape with inclined faces in wedge-base lamps.

The invention thus provides a socket perfectly adapted to use in a signalling device for automobiles.

According to another preferred characteristic, the connection strips are produced from spring steel. According to a preferred embodiment, the connection strips are produced from stainless strip steel for springs.

The elastic part forming a clamp of an electrical connection strip is perfectly designed so as to exert on the cap a gripping force adapted to the type of lamp, W16W or W5W.

Because of their separation into two distinct pieces, the centring piece and the base can easily be produced from different materials, the material of the centring piece being chosen so as to be suitable for direct thermal contact with the bottom of the bulb.

This separation into two distinct pieces also offers the advantage of keeping a standard base and modifying only the centring piece when it is wished to adapt the socket according to the invention to various types of lamp, for example W16W or W5W.

The centring piece is preferably produced from polycarbonate and the base is produced from polypropylene. the use of a low-cost material such as polypropylene for the base allows a better cost compromise for manufacturing the socket.

According to a preferred embodiment, the centring piece comprises two legs axially symmetrical extending from its first face and able to snap onto the base and, on the second face, at least four centring elements forming the part in contact with the bottom. At least one centring element preferably has the shape of a wedge, an inclined face of which is in contact with a splayed or inclined part of the bulb bottom.

According to yet another characteristic, the elastic part forming a clamp of a connection strip comprises two elastic contact lugs opposite each other and forming between them a gripping area, the contact lugs having a profile substantially in a curve and comprising three ends separated from each other and oriented towards the bulb.

According to another preferred embodiment, the socket according to the invention is integrated into a lamp holder for a lighting and/or signalling device comprising several sockets.

Correspondingly, the invention also concerns a lighting and/or signalling device, in particular for an automobile, in which there is included at least one socket as briefly described above.

Other aspects and advantages of the present invention will emerge more clearly from a reading of the description of particular embodiments that follows, this description being given by way of non-limiting example and made with reference to the accompanying drawings, in which:

### BRIEF DESCRIPTION OF THE DRAWINGS

FIG. 1 is an overall perspective view of a socket according to the invention and the lamp carried by it;

FIG. 2 is a perspective view of a base included in the socket of FIG. 1;

FIG. 3 is a perspective view of two electrical contact blades included in the socket of FIG. 1;

FIG. 4 is a perspective view of a centring ring included in the socket of FIG. 1;

FIG. 5 is a view in axial section of the ring of FIG. 4 and also shows the positioning of a lamp with respect to the ring;

FIG. 6 is a view in section of a socket according to the prior art.

### DESCRIPTION OF THE PREFERRED EMBODIMENTS

The invention is now described in detail, essentially through a preferred embodiment in which the socket according to the invention is integrated in a lamp holder intended to be mounted on a unit of signalling lights for an automobile.

A lamp holder for signalling lights is conventionally formed from a moulded plastic body equipped with means of mechanical assembly and electrical connection. Lamps are inserted in the corresponding sockets in the lamp holder in order to be connected to the electrical supply circuit of the vehicle and form the light sources of the various lights in the signalling unit. After the insertion of the lamps, the lamp holder is assembled on the signalling unit and closes a rear opening in the latter.

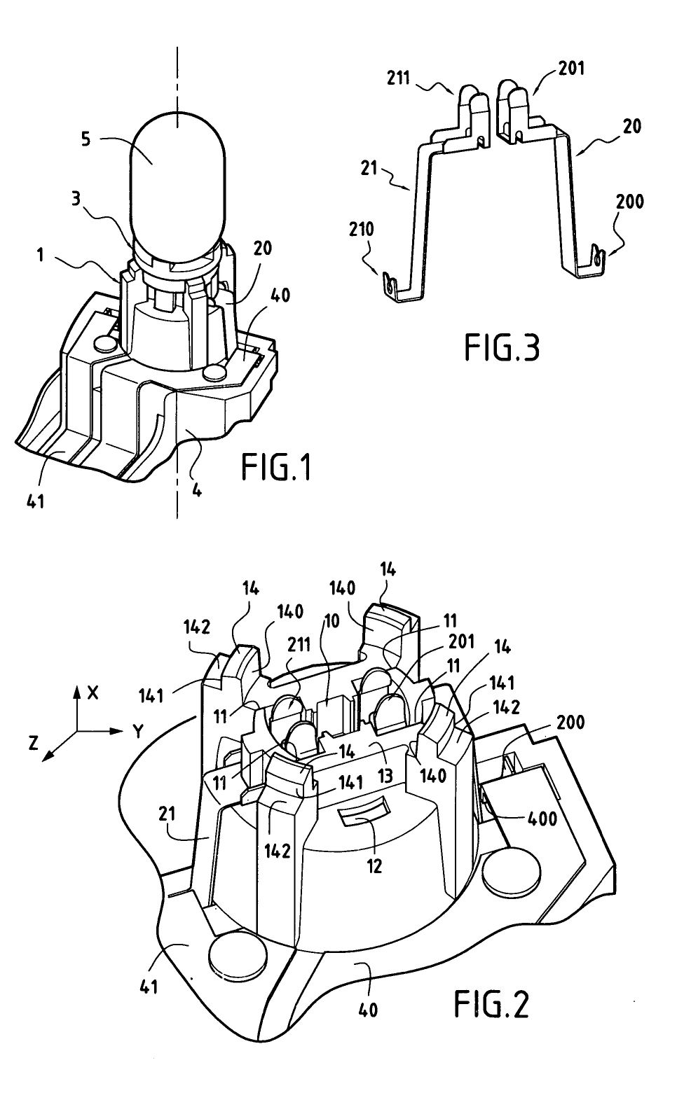

With reference to FIGS. 1 and 2, the socket according to the invention comprises essentially a base 1, electrical connection strips 20 and 21 and a centring ring 3.

As shown in FIG. 1, a wedge-base lamp 5, for example of the W16W type, is inserted in the socket.

In this preferred embodiment, the base 1 is moulded along with the body 4 of the lamp holder and therefore forms a single piece with it. The body 4 is shown only partially in FIG. 1.

The base 1 and body 4 are produced here from the same low-cost material such as for example polypropylene. The base 1 is preferably produced in the form of a roughly hollow body.

As shown also in FIGS. 1 and 2, conductive strips 40 and 41 forming part of an electrical circuit cut from the lamp holder are provided in order to connect the contact blades 20 and 21 to the electrical supply circuit of the vehicle.

The conductive strips 40 and 41 comprise folded-over ends (the folded-over end 400 of the strip 40 is shown in FIG. 2) that engage in female connection parts 200 and 210 of the contact blades 20 and 21, respectively.

The contact blades 20 and 21 are shown in detail in FIG. 3 with the same position with respect to each other as that which they have once mounted in the base 1.

The contact blades 20 and 21 have in this embodiment substantially identical shapes and dimensions. Naturally the contact blades can be different in other embodiments.

As shown in FIG. 3, each contact blade 20, 21 comprises an elastic part forming a clamp 201, 211 in which the glass cap of the lamp 5 is inserted.

The parts forming a clamp 201, 211 are housed in a top open cavity 10 (FIG. 2) in the base 1. Four notches 11 are also provided in the base 1 in order to be able to install the parts forming a clamp 201 and 211 in the cavity 10.

A part forming a clamp 201, 211 comprises two elastic contact lugs opposite each other and forming between them a gripping area. The contact lugs have a profile substantially in a curve. The gripping area between the contact lugs is situated roughly convex surface parts of these.

When the cap of the lug 5 is inserted between the lugs of an electrical contact blade, an electrical connection is established between the lugs and a wired electrode of the lamp 5.

The opposite contact lugs are connected in their bottom parts and form at these a common portion 202, 212, which is extended as far as the female connection part 200, 210. In their top parts, the contact lugs comprise three ends oriented towards the bulb of the lamp 5. These three ends are separated from each other by the effect of the curved profile of the contact lugs thus facilitating the insertion of the cap of the lamp 5 between the contact lugs.

According to the invention, the contact blades 20, 21 are preferably made from spring steel. More precisely, in this preferred embodiment, the contact blades are produced from stainless strip steel for springs.

The tests carried out by the inventors have shown that spring steel, unlike brass and other materials normally used for the electrical contacts in the sockets, makes it possible to obtain a gripping force able to guarantee the correct retention of the lamp 5 in the socket. The elastic parts forming a clamp 201, 211 are preferably designed so as to exert on the cap a gripping force adapted to the type of lamp, W16W or W5W.

It should be noted here that the terms “correct retention” should be interpreted in the context of automobile lighting and signalling. Thus the retention of the lamp 5 in the socket will be deemed to be correct if constraints of maximum movements of the lamp with respect to the socket are satisfied when given mechanical forces, such as vibrations and shocks, are applied to the lamp-socket assembly. This is because, when the lamp is assembled with the optical elements of the signalling lamp and is subjected to mechanical stresses, the movements of its filament must remain within clearly determined limits with respect to a focus of these optical elements, in order not to interfere with the optical performance of the light.

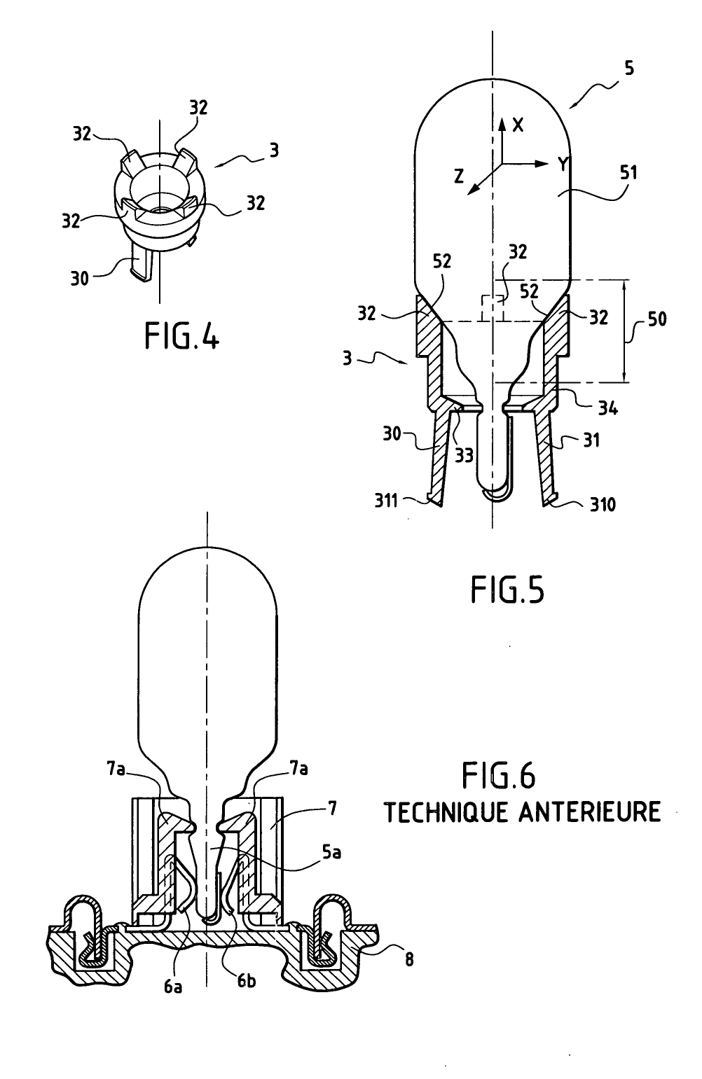

With reference more particularly to FIGS. 4 and 5, the centring ring 3 is now described.

The centring ring 3 has overall the shape of a hollow cylinder of revolution that is extended in its bottom part by two axially symmetrical legs 30 and 31. In its top part, the centring ring 3 comprises four centring elements 32 which, in this preferred embodiment, are each in the form of a wedge.

In accordance with the invention, the centring ring 3 is produced from a material able to withstand the thermal stresses imposed by the lamp 5, and in particular with a direct contact with the bulb of the lamp 5. For example, the centring ring 3 can be produced from polycarbonate (PC).

The function of the legs 30 and 31 is to lock the centring ring 3 on the base 1 by snapping on. The lugs 30 and 31 comprise respectively projecting lugs 310 and 311 situated at their bottom free ends.

When the ring 3 is mounted on the base 1, the bottom ends of the legs 30 and 31 are inserted respectively in two complementary snapping-in notches 12 shown in FIG. 2. A bottom annular face 33 of the ring 3 then comes into contact with a top face 13 of the base 1, thus ensuring positioning along the axis X. The lugs 310 and 311 hook onto an internal rim in the snapping-in notches 12, thus locking the ring 3 on the base 1.

A positioning of the ring 3 in the base 1 along the two perpendicular axes Y and Z is obtained by means of four elements forming stops 14 of the base 1.

The stops 14 are shown in FIG. 2. The four stops 14 are situated around the axis of symmetry along X of the base 1, on a circle perpendicular to the axis of symmetry and centred on it. The stops 14 are separated from each other by an angle of 45°. Each stop 14 comprises a face 140 oriented towards the axis of symmetry of the base 1, which is designed to come into positioning contact with a contour wall 34 of the ring 3.

A face 141 and a rim 142 will also be noted in FIG. 2, which are also provided in each of the stops 14 for positioning the socket in an optical device such as a reflector of the light.

Naturally the above description of the stops 14 should not be interpreted limitingly, since the stops 14 can be modified by a person skilled in the art in order to adapt the socket according to the invention to various possible applications. Thus for example, in certain variants, the stops 14 can be replaced by a collar provided with notches provided for the mounting of the contact blades 20 and 21 in the base 1.

With reference once again to FIGS. 4 and 5, the wedges 32 on the ring 3 each comprise an inclined face intended to come into contact with the bulb of the lamp 5, at a bottom 50 of the bulb.

The bottom of the bulb is a lower part of the bulb, adjacent to the lamp cap. As shown in FIG. 5, in this embodiment adapted to a W16W lamp, the bottom 60 is situated between a cylindrical portion of revolution 51 of the bulb and the cap of the lamp 5.

Preferably in this embodiment for a W16W lamp, the contact of the wedges 32 with the bottom 50 occurs at a splayed part 52 of the latter.

In the case of an embodiment adapted to a W5W lamp, the bottom of the bulb of the W5W lamp comprises two inclined faces substantially planar and axially symmetrical, at which the contact with the wedges 32 preferably occurs.

The above description of the centring elements 32 should not be interpreted limitingly, since the number and form of these elements 32 can be modified by a person skilled in the art in order to adapt the socket according to the invention to various possible applications.

Thus for example, in other embodiments, the centring elements 32 can be replaced by a collar offering continuous contact over a complete circumference of the base 50.

It should be noted however that the preferred embodiment described here, with several discrete centring elements, offers the advantage of thermal contacts with the bulb which remain at isolated points. The temperature of the centring ring is thus less high than that which would be reached with a larger contact surface, thus improving the resistance of the material over time.

What is claimed is:

1. Socket for a wedge-base lamp comprising a base and at least two electrical contact blades mounted in the said base in order to electrically connect electrodes of the lamp to an electrical supply circuit, the said electrical contact blades each comprising an elastic part forming a clamp in which the said glass cap of the lamp is inserted, wherein the said base comprises a centring piece produced in the form of a ring extended, on a first face, by at least one leg able to provide a fixed positioning of the said centring piece on the said base and having, on a second face, centring elements forming a part in contact with the bottom of the bulb of the lamp in order to centre the lamp in a predetermined manner in the said base and to oppose any movement of the lamp with respect to the said base.

2. Socket according to claim 1, wherein the said contact blades are produced from spring steel or stainless steel leaf for springs.

3. Socket according to claim 1, wherein the said elastic part forming a clamp is designed so as to exert on the said cap a clamping force adapted to the type of lamp.

4. Socket according to claim 1, wherein the said centring piece and the said base are produced from different materials, the material of the said centring piece being chosen so as to be suitable for direct thermal contact with the said bottom.

5. Socket according to claim 4, wherein the said centring piece is produced from polycarbonate and the said base is produced from polypropylene.

6. Socket according to claim 1, wherein the said centring piece comprises two axially symmetrical legs extending from its first face and able to snap onto the said base and on the second face at least four centring elements forming the said part in contact with the said bottom brackets.

7. Socket according to claim 6, wherein at least one of the said centring elements has the shape of a wedge, the inclined face of which is in contact with a splayed or inclined part of the said base.

8. Socket according to claim 1, wherein the said elastic part forming a clamp of a said contact blade comprises two elastic contact lugs opposite each other and forming between them a gripping area, the said contact lugs having a profile substantially in a curve and comprising free ends separated from each other and oriented towards the said bulb.

9. Socket according to claim 1, wherein it is integrated in a lamp holder for a lighting and/or signalling device comprising several sockets.

10. Lighting and/or signalling device, in particular for an automobile, comprising at least one socket according to claim 1.
